(19) United States
(12) Patent Application Publication
(10) Pub. No.: US 2004/0213647 A1
(43) Pub. Date: Oct. 28, 2004

(54) Device for the transport of metallic work pieces

(76) Inventors: Karl-Heinz Lemken, Kleve (DE); Johann Duin, Bedburg-Hau (DE); Georg Cluse, Kleve (DE)

Correspondence Address: Daniel F. Drexler, CANTOR COLBURN LLP, 55 Griffin Road South, Bloomfield, CT, 06002, US

(21) Appl. No.: 10/808,028

(22) Filed: Mar. 23, 2004

(30) Foreign Application Priority Data
Apr. 11, 2003 (EP) 03008400.8

(51) Int. Cl. B66C 17/08

(52) U.S. Cl. 414/154

(57) ABSTRACT

The invention concerns a device for the transport of metallic work pieces, in particular, during the heat treatment process. In order to suggest a device that makes cost savings and increased transport capacity possible, an invention is suggested with a device for the transport of metallic work pieces comprising a heat-insulated and vacuum-proof transport chamber for heated transports, a transport device for cold transports and a common drive for the transport chamber and the transport device.

The invention concerns a device for the transport of metallic work pieces, in particular during a heat treatment process.

Such a device is known, for example from EP 1 229 137. It serves for the transport of metallic work pieces between individual heat treatment chambers that are approached in a predetermined sequence within the framework of the heat treatment process and which can be loaded and unloaded via the transport device.

In order to ensure that the work pieces do not cool unscheduled and uncontrolled and/or are not exposed to the atmosphere surrounding the heat treatment chamber following completion of a treatment process in a heat treatment chamber, the device for the transport is equipped with a transport chamber that is heat-insulated and vacuum-tight. Thus, heat treated work pieces can be moved out of the heat treatment chamber, transferred into the transport chamber and transferred for further treatment to another heat treatment chamber without the disruptive effects of external influences that cannot be calculated.

The transport device known from EP 1 229 137 is designed to comprise a mobile carriage that can be moved relative to the individual heat treatment chamber, which carries a transport chamber that is heat insulated and vacuum-tight. The transport chamber can approach the individual heat treatment chambers via the carriage when necessary, whereby the transport chamber is mobile relative to the carriage for a precise coupling to the heat treatment chambers, making it possible for the transport chamber to also be aligned perpendicular to the drive direction of the carriage.

The transport chamber of the above described transport device is designed for the heated transport of heat-treated work pieces. In order to transport cold charges unaffected, for example at the beginning of a heat treatment process, the transport chamber must first be cooled with a cooling fan. First the transport chamber must be set under atmospheric pressure so that the cold charge can be introduced into the transport chamber. Once the cold charge has been introduced into the first heat treatment chamber, the transport chamber must be heated and then evacuated in order to allow the transport, free from all external influences, of the treated work pieces to the next heat treatment chamber upon completion of the treatment process within the first heat treatment chamber. As soon as the whole heat treatment process is finished, the transport chamber must be cooled again for the next cold charge and then brought to the appropriate atmospheric pressure.

The repeated heating and cooling of the transportation chamber within the framework of the heat treatment process has the disadvantage of a high outlay in energy and in costs. The same goes for evacuating and flooding of the transport chamber that must be repeated within the framework of the process execution. It is also disadvantageous that the evacuation process as well as the heating of the transport chamber is very time-intensive, which leads in total to a prolonged process execution.

Based on these facts, experts are faced with the task of providing a device for the transport of metallic work pieces that facilitates a heightened transport capacity by avoiding the previously mentioned disadvantages with simultaneous cost savings.

For the solution of the problem with the invention, a device is suggested for the transport of metallic work pieces, in particular during a heat treatment process, comprising a heat-insulated and vacuum-tight transport chamber for heated transport, a transport device for cold transport, and a common drive for the transport chamber and the transport device.

According to the invention, the suggested transport device is equipped with a transport chamber for heated transport on the one hand and a transport device for cold transport on the other hand. Thus, cold charges to be transported can be transferred advantageously via a transport device, so that the transport of cold charges does not require cooling of the transport chamber or pressurization of it to the atmospheric pressure. The device according to the invention saves energy and time for the transport of cold—as well as heated charges, whereby the transport chambers and the transport device can also be used simultaneously.

The special advantage of the device according to the invention is based on the option of differentiating between heated transport on the one hand and cold transport on the other hand. The work pieces to be transported only cold can be transported via a simple method without it being necessary to first shut down the heated and evacuated transport chamber, i.e. to cool it and to adjust the pressure to the external atmosphere. This not only saves energy but also time in view of the necessary reheating and evacuation of the transport chamber following a cold transport, meaning that the device according to the invention achieves in total a significantly higher transport capacity. In addition, a simultaneous transport of heated and cold charges can take place with the device according to the invention, whereby an additional increase in the transport capacity can be achieved.

A common drive is planned for the transport chamber and the transport device to ensure an advantageous and simultaneous process for the transport chamber and the transport device. For loading or unloading of either the transport chamber or the transport device it is necessary only to move the device according to the invention far enough that the transport device or the transport chamber can be coupled to the appropriate treatment chamber as needed. Naturally it is also possible to couple a treatment chamber with the transport chamber in a first step, and in a second step to move the device only so far that one and the same treatment chamber can be coupled with the transport device.

According to a further characterizing feature of the invention the device is equipped with a mobile carriage. According to this design example, the device according to the invention is equipped with a common carriage for the transport chamber and the transport device. According to this design example, the carriage forms a total rack that can be produced especially economically. Located on this common rack are both the relative mobile carrying rack for the transport chamber and the transport device. With this type of design it is possible to move the transport chamber and the transport device independently of one another relative to the carriage, which enables an alignment as needed either of the transport chamber or the transport device relative to the approaching transport chamber.

As an alternative to the previously described design example, an additional mobile carriage can be provided whereby one carriage accepts the carrying rack for the transport chamber and the other carriage the carrying rack for the transport device. In this design example, therefore, two separate carriages are provided. The advantage of this design example is the option of coupling different carriages to one another by means of combinations. This is especially advantageous in terms of retrofitting, as this type of design allows the combination of already existing devices consisting only of a transport chamber for heated transport with a transport device of the above described type. With the option of coupling based upon need, a transport device can be constructed that consists, for example, of a transport chamber and a total of two transport devices, wherein the two transport devices are located on the left side and the right side of the transport chamber, resulting together in a device for the transport of metallic work pieces that has a transport chamber in the center between two transport devices.

The individual carriages can be coupled to one another in the traditional art and manner, wherein it is preferable for the carriage that bears the transport chamber to be equipped with an appropriate drive. This carriage can be designated as drawing gear, while the coupled carriages that are not equipped with separate drives serve as trailers for the transport device.

Depending upon the design example either a common drive or a separate drive can be provided for the movement of the transport chamber or the transport device relative to the carriage. Preferably, in the case of a coupling of individual carriages in each case a separate drive is provided for the movement of the carrying rack relative to the corresponding carriage, as this facilitates a simplified coupling option.

According to a further characterizing feature of the invention the transport chamber and the transport device are each equipped with a separate loading system. A corresponding loading system is described in EP 1 229 137 to which a special reference is made here.

According to a preferred design example of the invention, it is provided that the transport device is a transport chamber. This is an advantage in particular for economic reasons as the previously described transport chambers can be used as transport devices in order to simplify matters, whereby all devices for the heating and evacuation of the transport chamber can be omitted. Also, it is not necessary to provide a drive unit because the transport chamber that serves as a transport device for cold charges is coupled with a transport chamber that is equipped with a drive.

Additionally, according to the invention a system is proposed for the heat treatment especially of metallic work pieces with a multitude of separate treatment chambers, wherein this system comprises transport devices of the previously mentioned type. Such a system enables a simplified and more less time- and cost-effective transport process for the heat treatment of metallic work pieces. It is further proposed that the transport chamber and the transport device can be loaded and unloaded independently from one another so that either the transport chamber or the transport device can be moved to a treatment chamber and be loaded or unloaded, depending upon the process being executed.

According to an further characterizing feature of the system, the transport device can be loaded and/or unloaded on both sides. This design example is especially advantageous when treatment chambers are located on both sides of the pathway for the treatment device so that it is possible to use one and the same transport device for loading or unloading the treatment chambers located on both sides, without significant shunting.

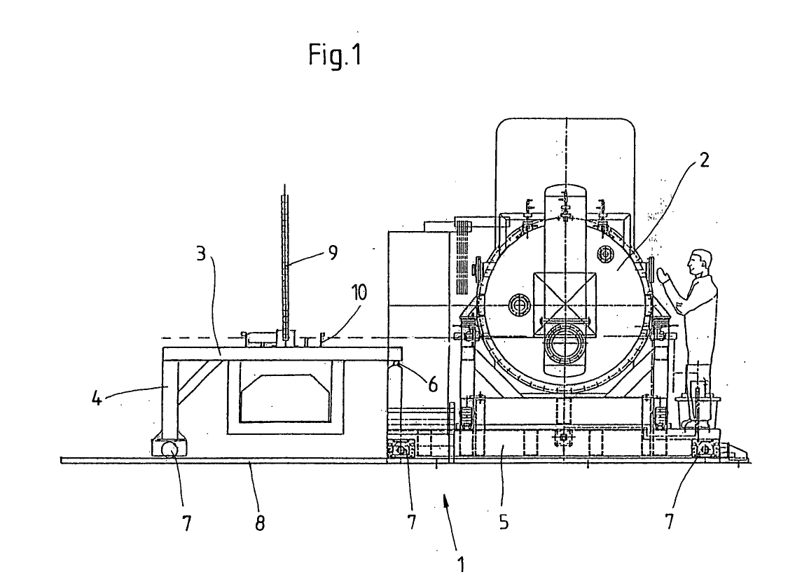

Further advantages and characterizing features of the invention result from the description of FIG. 1 that depicts the device according to the invention.

Shown in FIG. 1 is a device 1 according to the invention for the transport especially of metallic work pieces. The device 1 comprises on the one hand a heat-insulated and vacuum-tight transport chamber 2 for heated transport, and on the other hand a transport device 3 for cold transports. The transport chamber 2 is borne by a carriage 5, and the transport device 3 is borne by a carriage 4. In a jointed charge point 6, the two carriages 4 and 5 are coupled together forming a common carriage unit. The jointed charge point balances the lack of balance in the rails, ensuring in any case that the rolls 7 bearing the carriages 4 and 5 are always in contact with the rails 8.

As an alternative to the coupling of two carriages 4 and 5 a common carriage can be provided for the transport chamber 2 and the transport device 3, which bears both the transport chamber 2 and the transport chamber 3.

The device 1 according to the invention is driven by a drive that is not shown in great detail in FIG. 1, which is part of the carriage 5 that bears the transport chamber 2. This carriage 5 serves as draw gear for the carriage 4, which can be designated as a trailer device due to the power-transferring coupling.

With respect to the precise construction and functionality of the transport chamber 2 and that of the carriage 5 that bears the transport chamber 2, please refer to the contents of the European patent application EP 1 229 137 A1.

The special advantage of the device according to the invention lies in the fact that the allocation of a transport device that is used only for cold charge transports creates the option that the transport chamber 2 designed for heated transport need not be constantly heated and cooled. A repeated evacuation of the transport chamber 2 can also be avoided with the additional use of the transport device 3, which is advantageously energy and time saving.

A loading system in the form of a pressure chain 9 is provided for the loading and unloading of the transport device 3. This advantageously facilitates a simple loading for the acceptance of the transport device 3, preferably in the form of a loading table. Here, the pressure chain 9 is designed in such a way that it facilitates the loading and unloading of the transport device 3 on both sides. For securing the charge on the transport device 3, charge guides 10 with vented borders are provided.

Reference Numbers

1 Transport System Device

2 Transport Chamber

3 Transport Device

4 Carriage

5 Carriage

6 Charge Point

7 Roller

8 Rail

9 Pressure Chain

10 Charge Guide

1. Device for transport of metallic work pieces during a heat treatment process, comprising: a heat-insulated and vacuum-tight transport chamber for heat transports, a transport device for cold transports, and a common drive for the transport chamber and the transport device.

2. Device according to claim 1, further comprising a mobile carriage.

3. Device according to claim 2, further comprising a carrying rack located relative to the carriage for the transport chamber and the transport device.

4. Device according to claims 1, further comprising a first mobile carriage for supporting a carrying rack for the transport chamber and a second mobile carriage for supporting a carrying rack for the transport device.

5. Device according to claim 4, wherein the two carriages are coupled with one another.

6. Device according to claim 1, wherein the transport chamber and the transport device are each equipped with a separate loading system.

7. Device according to claim 1, wherein the transport device is equipped with a loading table.

8. Device according to claim 1, wherein the transport device is a second transport chamber.

9. System for heat treatment of metallic work pieces, with a multitude of separate treatment chambers comprising a transport device according to claim 1.

10. System according to claim 9, wherein the transport chamber and the transport device can be loaded and unloaded independently of one another.

11. Facility according to claim 9, wherein the transport device can be loaded and unloaded on both sides thereof.
